(19) United States
(12) Patent Application Publication
(10) Pub. No.: US 2015/0363558 A1
(43) Pub. Date: Dec. 17, 2015

(54) Method of Determining Predisposition to Endometriosis

(71) Applicants: Kenneth Ward, Salt Lake City, UT (US); Pamela Farrington, Salt Lake City, UT (US); Rakesh N. Chettier, West Jordan, UT (US); Hans Albertsen, Salt Lake City, UT (US)

(72) Inventors: Kenneth Ward, Salt Lake City, UT (US); Pamela Farrington, Salt Lake City, UT (US); Rakesh N. Chettier, West Jordan, UT (US); Hans Albertsen, Salt Lake City, UT (US)

(73) Assignee: JUNEAU BIOSCIENCES, LLC, Salt Lake city, UT (US)

(21) Appl. No.: 13/603,284

(22) Filed: Sep. 4, 2012

Related U.S. Application Data
(60) Provisional application No. 61/530,945, filed on Sep. 3, 2011.

(51) Int. Cl. G06F 19/24; A61B 5/00; A61P 15/00; C12Q 1/68; A61K 45/00

(52) U.S. Cl. CPC G06F 19/345

(57) ABSTRACT

The present invention relates to novel genetic markers associated with endometriosis and risk of developing endometriosis, and methods and materials for determining whether a human subject has endometriosis or is at risk of developing endometriosis and the use of such risk information in selectively administering a treatment that at least partially prevents or compensates for an endometriosis related symptom.

### CROSS REFERENCE TO RELATED APPLICATIONS

This US nonprovisional utility patent application claims the benefit under 35 USC §119(e) of U.S. provisional application No. 61/530,945 filed Sep. 3, 2011 which is incorporated in its entirety by this reference.

### FIELD OF THE INVENTION

The present invention relates to endometriosis prognosis, diagnosis and therapy. In particular, the present invention relates to a novel algorithmic combination of endometriosis associated single nucleotide polymorphisms (SNPs) and endometriosis related clinical analysis to result in an endometriosis predictive and/or diagnostic test.

### BACKGROUND OF THE INVENTION

Endometriosis in one instance refers to autoimmune endometriosis, mild endometriosis, moderate endometriosis or severe endometriosis. For the purpose of this invention the term endometriosis is used to describe any of these conditions.

Endometriosis is most generally defined as the presence of endometrium (glands and stroma) at sites outside of the uterus (ectopic endometrial tissues rather than eutopic or within the uterus). The most common sites are the ovaries, pelvic peritoneum, uterosacral ligaments, pouch of Douglas, and rectovaginal septum although implants have been identified on the peritoneal surfaces of the abdomen (these may grow into the intestines, ureters or bladder), in the thorax, at the umbilicus, and at incision sites of prior surgeries (Child T J, Tan S L (2001) Endometriosis: aetiology, pathogenesis and treatment, Drugs 61:1735-1750; Giudice et al. (1998) Status of current research on endometriosis, The Journal of reproductive medicine 43:252-262).

Endometriosis is a common gynecologic disorder. The prevalence is difficult to know. It has been estimated that it affects approximately 14% of all women (range 1-43%), 40-60% of women with pelvic pain and 30%-50% of infertile women (Di Blasio et al. (2005) Genetics of endometriosis, Minerva ginecologica 57:225-236; Schindler AE (2004) Pathophysiology, diagnosis and treatment of endometriosis, Minerva ginecologica 56:419-435).

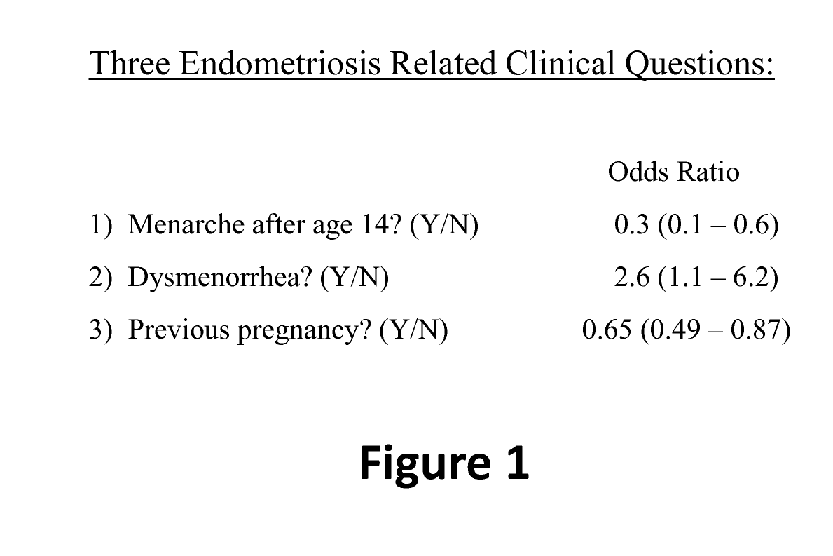

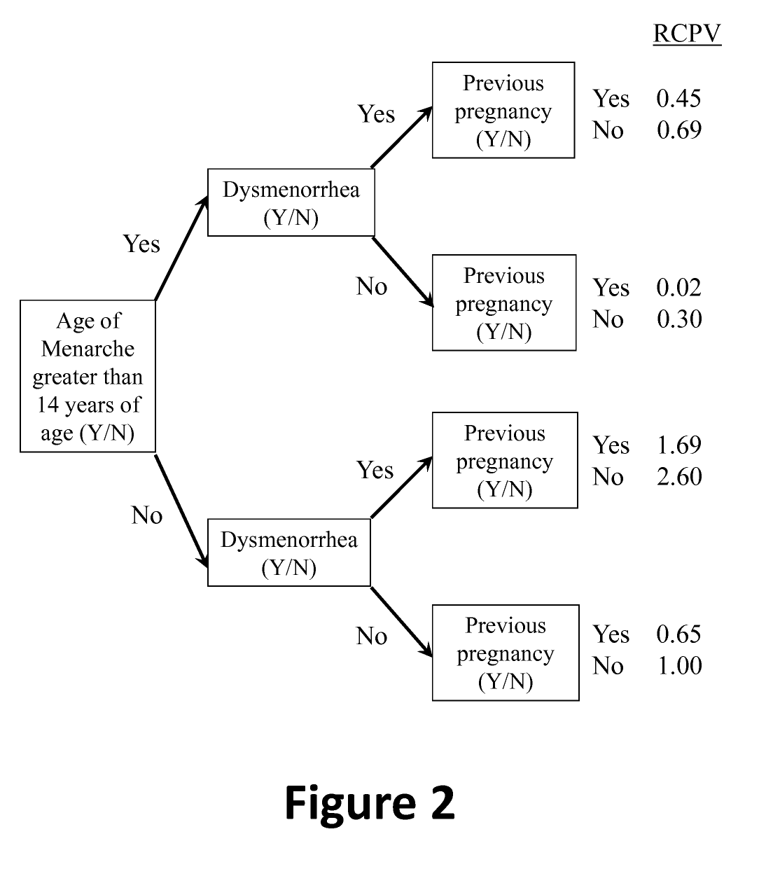

A generally accepted non-surgical method of assessing a predisposition to endometriosis is to determine the answer to three distinct endometriosis related questions, each question having an associated Odds Ratio (OR), as shown in FIG. 1 (see also appendix A). The results of answers to the FIG. 1 questions are then complied according to the endometriosis clinical factor assessment chart as shown in FIG. 2 (see also appendix B) resulting in a Raw Clinical Probability Value (RCPV). The RCPV is preferably multiplied by a Relevance Factor (RF) based on a patient's age and race to result in a Final Clinical Probability Value (FCPV). Alternatively, the RCPV may be used with data collected in population surveys.

MultiDimensional Analysis (MDA) is an analysis process that groups data into two or more categories (e.g. cases and controls or patients having a high probability of endometriosis and patients having a low probability of endometriosis) according to appendix C.

Logistic regression analysis is a process that is used for prediction of the probability of occurrence of an event by fitting data to a logit function logistic curve according to appendix D.

Bayesian analysis or Bayesian interference is a method of statistical inference in which evidence is used to estimate parameters and predictions in a probability model according to appendix E.

Various genetic markers are known to have a predictive association with endometriosis. Such genetic markers and methods are disclosed for instance in U.S. patent application Ser. Nos. 12/056,754, 12/120,322, 12/566,933, 12/765,643, 13/159,132, 13/602,409, 61/530,947, and 61/547,624, all of which are incorporated herein in their entirety by this reference.

### SUMMARY OF THE INVENTION

The present invention defines a method for endometriosis diagnosis/prognosis that combines known endometriosis clinical factor assessment methods with endometriosis associated single nucleotide polymorphisms (SNPs) (or functionally comparable biomarkers) via a statistical assessment method such as MultiDimensional Scaling analysis (MDS), logistic regression, or Bayesian analysis.

It shall be noted that “Linkage disequilibrium” or “LD” means that a particular combination of alleles (alternative nucleotides) or genetic markers at two or more different SNP sites are non-randomly co-inherited (i.e., the combination of alleles at the different SNP sites occurs more or less frequently in a population than the separate frequencies of occurrence of each allele or the frequency of a random formation of haplotypes from alleles in a given population). The term “LD” differs from “linkage,” which describes the association of two or more loci on a chromosome with limited recombination between them. LD is also used to refer to any non-random genetic association between allele(s) at two or more different SNP sites. Therefore, when a SNP is in LD with other SNPs, the particular allele of the first SNP often predicts which alleles will be present in those SNPs in LD. LD is generally, but not exclusively, due to the physical proximity of the two loci along a chromosome. Hence, genotyping one of the SNP sites will give almost the same information as genotyping the other SNP site that is in LD. Linkage disequilibrium is caused by fitness interactions between genes or by such non-adaptive processes as population structure, inbreeding, and stochastic effects.

It shall also be noted that LD is the non-random association of alleles adjacent loci. When a particular allele at one locus is found together on the same chromosome with a specific allele at a second locus-more often than expected if the loci were segregating independently in a population—the loci are in disequilibrium. This concept of LD is formalized by one of the earliest measures of disequilibrium to be proposed (symbolized by D). D, in common with most other measures of LD, quantifies disequilibrium as the difference between the observed frequency of a two-locus haplotype and the frequency it would be expected to show if the alleles are segregating at random. A wide variety of statistics have been proposed to measure the amount of LD, and these have different strengths, depending on the context. Although the measure D has the intuitive concepts of LD, its numerical value is of little use for measuring the strength of and comparing levels of LD. This is due to the dependence of D on allele frequencies. The two most common measures are the absolute value of D′ and r². The absolute value of D′ is determined by dividing D by its maximum possible value, given the allele frequencies at the two loci. The case of D′=1 is known as complete LD (or CLD). The measure r² is in some ways complementary to D′. An r2 value of 1 indicates complete LD as well while an r2 value of 0 indicates linkage equilibrium. Complete LD demonstrates complete dependency. In other words, in complete LD the number of counts of the minor allele in loci 1 corresponds to the counts of minor allele in loci 2. Although in complete LD the alleles themselves might be different the frequency of Minor allele in loci 1 will be equal to the frequency of Minor allele in loci 2. For example, in comparing two loci such as rs1 having (A/G) and rs2 having (G/C), if it is known that rs1 and rs2 are in complete LD, then if a person carries a genotype AG on rs1 then it is known that the genotype on rs2 is GC for that person. Similarly in complete LD, if A is the minor allele of rs1 and is associated with the disease (or conversely is not associated with the disease) then the corresponding minor allele of rs2 is also associated with the disease (or conversely or is not associated with the disease). Furthermore in complete LD, in any analysis of the disease, genotype for rs1 could easily be substituted for rs2 and vice versa.

It shall also be noted that unless indicated otherwise, when a SNP is identified as the genetic marker associated with a disease (in this case endometriosis), that it shall be understood that it is the minor allele (MA) of the particular SNP that is associated with the disease. Further it shall also be noted that unless indicated otherwise, if the Odds Ratio (OR) of the MA is greater than 1.0, the presence of the MA of the SNP (in this case the endometriosis associated genetic marker) is correlated with an increased risk of endometriosis and the absence of the MA of the SNP is correlated with a decreased risk of endometriosis, and that if the OR of the MA less than 1.0, the presence of the MA of the SNP is correlated with a decreased risk of endometriosis and the absence of the MA of the SNP is correlated with an increased risk of endometriosis.

### DETAILED DESCRIPTION OF THE INVENTION

The method of determining predisposition to endometriosis for a patient is performed according to the following steps. In a first step, answers to the FIG. 1 questions are obtained for the patient. In a second step, an RCPV according to FIG. 2 is determined for the patient based on the answers obtained for the patient in step 1. In an optional third step, the RCPV is optionally multiplied by an RF or otherwise adjusted according to the patient's age and race or according to relevant population survey data to result in a FCPV. In a fourth step, at least one endometriosis associated marker is identified in genetic material of the patient. In a fifth step, at least one statistical analysis (preferably MDS) is performed to combine the RCPV (or the FCPV) and the predictive value of the identified genetic marker to result in a highly predictive endometriosis prognosis or diagnosis.

1. A method for determining existence or predisposition of endometriosis in a subject for which data exists regarding at least one endometriosis associated genetic marker known to exist in the genetic material of said subject, comprising:
obtaining clinical data of said subject, and
performing a statistical analysis of said clinical data and said endometriosis associated genetic marker data to result in an endometriosis existence or predisposition assessment of said subject.

2. The method of claim 1, wherein said clinical data defines a determination of age of menarche, dysmenorrhea, and pregnancy history.

3. The method of claim 2, wherein said clinical data is assigned an odds ratio (OR) substantially according to FIG. 1.

4. The method of claim 2, wherein an RCPV is derived for said clinical data substantially according to the logic of FIG. 2.

5. The method of claim 4, wherein said RCPV is multiplied by an RF corresponding to said subject's age and race to result in an FCPV.

6. The method of claim 1, wherein said statistical analysis defines at least one of MDA, logistic regression, and Bayesian analysis.

7. The method of claim 1, wherein said genetic marker defines the minor allele of at least one marker disclosed in Table 001 of Ser. No. 12/765,643.

8. The method of claim 1, wherein said subject defines an endometriosis asymptomatic subject.

9. The method of claim 1, wherein said method includes performing at least one of administering at least one of a therapeutic that at least partially compensates for an endometriosis related condition and preventing or cancelling an invasive endometriosis diagnostic procedure.

10. The method of claim 9, wherein said therapeutic defines an ovulation suppression substance, and wherein said invasive endometriosis diagnostic procedure defines laparoscopy.

11. A method for determining existence or predisposition of endometriosis in a subject, comprising:
assaying and detecting at least one endometriosis associated genetic marker in the genetic material of said subject to result in endometriosis associated genetic marker data,
obtaining clinical data of said subject, and
performing a statistical analysis of said clinical data and said endometriosis associated genetic marker data to result in an endometriosis existence or predisposition assessment of said subject.

12. The method of claim 11, wherein said clinical data defines a determination of age of menarche, dysmenorrhea, and pregnancy history.

13. The method of claim 12, wherein said clinical data is assigned an odds ratio (OR) substantially according to FIG. 1.

14. The method of claim 12, wherein an RCPV is derived for said clinical data substantially according to the logic of FIG. 2.

15. The method of claim 14, wherein said RCPV is multiplied by an RF corresponding to said subject's age and race to result in an FCPV.

16. The method of claim 11, wherein said statistical analysis defines at least one of MDA, logistic regression, and Bayesian analysis.

17. The method of claim 11, wherein said genetic marker defines the minor allele of at least one marker disclosed in Table 001 of Ser. No. 12/765,643.

18. The method of claim 11, wherein said subject defines an endometriosis asymptomatic subject.

19. The method of claim 11, wherein said method includes performing at least one of administering at least one of a therapeutic that at least partially compensates for an endometriosis related condition and preventing or cancelling an invasive endometriosis diagnostic procedure.

20. The method of claim 17, wherein said therapeutic defines an ovulation suppression substance, and wherein said invasive endometriosis diagnostic procedure defines laparoscopy.

21. A method for treating a subject, comprising:
obtaining data of at least one endometriosis associated genetic marker in the genetic material of said subject,
obtaining clinical data of said subject,
performing a statistical analysis of said clinical data and said endometriosis associated genetic marker data to result in an endometriosis existence or predisposition assessment of said subject, and performing at least one of administering at least one of a therapeutic that at least partially compensates for an endometriosis related condition and preventing or cancelling an invasive endometriosis diagnostic procedure.

22. The method of claim 21, wherein said clinical data defines a determination of age of menarche, dysmenorrhea, and pregnancy history.

23. The method of claim 22, wherein said clinical data is assigned an odds ratio (OR) substantially according to FIG. 1.

24. The method of claim 22, wherein an RCPV is derived for said clinical data substantially according to the logic of FIG. 2.

25. The method of claim 24, wherein said RCPV is multiplied by an RF corresponding to said subject's age and race to result in an FCPV.

26. The method of claim 21, wherein said statistical analysis defines at least one of MDA, logistic regression, and Bayesian analysis.

27. The method of claim 21, wherein said genetic marker defines the minor allele of at least one marker disclosed in Table 001 of Ser. No. 12/765,643.

28. The method of claim 21, wherein said subject defines an endometriosis asymptomatic subject.

29. The method of claim 21, wherein said method includes performing at least one of administering at least one of a therapeutic that at least partially compensates for an endometriosis related condition and preventing or cancelling an invasive endometriosis diagnostic procedure.

30. The method of claim 29, wherein said therapeutic defines an ovulation suppression substance, and wherein said invasive endometriosis diagnostic procedure defines laparoscopy.

31. A method for treating an endometriosis asymptomatic subject, comprising:
obtaining data of at least one endometriosis associated genetic marker in the genetic material of said subject,
obtaining clinical data of said subject,
performing a statistical analysis of said clinical data and said endometriosis associated genetic marker data to result in an endometriosis existence or predisposition assessment of said subject, and
performing at least one of administering at least one of a therapeutic that at least partially compensates for an endometriosis related condition and preventing or cancelling an invasive endometriosis diagnostic procedure.

32. The method of claim 31, wherein said clinical data defines a determination of age of menarche, dysmenorrhea, and pregnancy history.

33. The method of claim 32, wherein said clinical data is assigned an odds ratio (OR) substantially according to FIG. 1.

34. The method of claim 32, wherein an RCPV is derived for said clinical data substantially according to the logic of FIG. 2.

35. The method of claim 34, wherein said RCPV is multiplied by an RF corresponding to said subject's age and race to result in an FCPV.

36. The method of claim 31, wherein said statistical analysis defines at least one of MDA, logistic regression, and Bayesian analysis.

37. The method of claim 31, wherein said genetic marker defines the minor allele of at least one marker disclosed in Table 001 of Ser. No. 12/765,643.

38. The method of claim 31, wherein said therapeutic defines an ovulation suppression substance, and wherein said invasive endometriosis diagnostic procedure defines laparoscopy.

39. A method for treating a subject, comprising:
assaying and detecting at least one endometriosis associated genetic marker defining the minor allele of at least one marker disclosed in Table 001 of Ser. No. 12/765,643 to result in endometriosis associated genetic marker data,
obtaining a determination of age of menarche, dysmenorrhea, and pregnancy history clinical data of said subject,
deriving an RCPV is derived for said clinical data substantially according to the logic of FIG. 2,
performing at least one of an MDA, logistic regression, and Bayesian analysis statistical analysis of said clinical data and said endometriosis associated genetic marker data to result in an endometriosis existence or predisposition assessment of said subject, and
performing at least one of administering at least one of a therapeutic that at least partially compensates for an endometriosis related condition and preventing or cancelling an invasive endometriosis diagnostic procedure.

40. The method of claim 39, wherein said clinical data is assigned an odds ratio (OR) substantially according to FIG. 1.

41. The method of claim 39, wherein said RCPV is multiplied by an RF corresponding to said subject's age and race to result in an FCPV.

42. The method of claim 39, wherein said therapeutic defines an ovulation suppression substance, and wherein said invasive endometriosis diagnostic procedure defines laparoscopy.

43. The method of claim 39, wherein said subject defines an endometriosis asymptomatic subject.
